(19) United States
(12) Patent Application Publication
(10) Pub. No.: US 2024/0292462 A1
(43) Pub. Date: Aug. 29, 2024

(54) METHOD, DEVICE AND COMPUTER READABLE MEDIUM FOR COMMUNICATIONS

(71) Applicant: NEC CORPORATION, Tokyo (JP)

(72) Inventors: Gang WANG, Beijing (CN); Zhaobang MIAO, Beijing (CN); Lin LIANG, Beijing (CN)

(73) Assignee: NEC CORPORATION, Tokyo (JP)

(21) Appl. No.: 18/686,675

(22) PCT Filed: Aug. 27, 2021
(86) PCT No.: PCT/CN2021/115148

§ 371 Date: Feb. 26, 2024

(51) Int. Cl. H04W 74/0816; H04W 74/08; H04W 92/18

(52) U.S. Cl. CPC H04W 74/0816; H04W 74/0875; H04W 92/18

(57) ABSTRACT

Embodiments of the present disclosure relate to methods, devices and computer readable media for communications. A method comprises determining, at a first terminal device, channel occupancy (CO) for sidelink transmission. The method further comprises transmitting configuration information about the CO.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP). SL-U should base on New Radio (NR) sidelink and NR-U.

For communication in unlicensed band between a network device and terminal devices, resources within a Channel Occupancy (CO) may be shared in a Time Division Multiplex (TDM) mode according to the scheduling of the network device.

For the case that sidelink communication is performed in unlicensed band, several characteristics make it hard to share resource in a CO on sidelink. For example, there is no scheduling node, no coordination between sidelink terminal devices, and sidelink communication has a different channel structure from the communication over Uu interface. If Channel Occupancy Time (COT) sharing is not supported for sidelink communication, it may decrease the resource efficiency in unlicensed band and confine the sidelink services.

### SUMMARY

In general, example embodiments of the present disclosure provide methods, devices and computer readable media for communications.

In a first aspect, there is provided a method for communications. The method comprises determining, at a first terminal device, channel occupancy (CO) for sidelink transmission. The method further comprises transmitting configuration information about the CO.

In a second aspect, there is provided a method for communications. The method comprises receiving, at a second terminal device from a first terminal device, configuration information about CO. The CO is determined by the first terminal device. The method further comprises transmitting sidelink transmission in the CO based on the configuration information about the CO.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in accordance with some embodiments of the present disclosure;

FIG. 4 illustrates an example of an interlace in accordance with some embodiments of the present disclosure;

FIG. 5 illustrates an example signaling chart showing an example process for CO sharing in accordance with some embodiments of the present disclosure;

FIGS. 6A to 6I illustrate an example of CO sharing in accordance with some embodiments of the present disclosure, respectively;

FIG. 7 illustrates an example of CO sharing in accordance with some other embodiments of the present disclosure;

FIG. 8 illustrates an example of CO sharing in accordance with some other embodiments of the present disclosure;

FIGS. 9A and 9B illustrate an example of CO sharing in accordance with still other embodiments of the present disclosure, respectively;

FIG. 10 illustrates a flowchart of an example method in accordance with some embodiments of the present disclosure;

FIG. 11 illustrates a flowchart of an example method in accordance with some other embodiments of the present disclosure;

FIGS. 12 to 14 illustrate a flowchart of an example of the method as shown in FIG. 11; and

FIG. 15 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, for the case that sidelink communication is performed in unlicensed band, several characteristics make it hard to share resource in a CO on sidelink. For example, there is no scheduling node, no coordination between sidelink terminal devices, and sidelink communication has a different channel structure from the communication over Uu interface. If Channel Occupancy Time (COT) sharing is not supported for sidelink communication, it may decrease the resource efficiency in unlicensed band and confine the sidelink services.

Embodiments of the present disclosure provide a solution for sidelink transmission so as to solve the above problems and one or more of other potential problems. According to the solution, a first terminal device determines channel occupancy (CO) for sidelink transmission of the first terminal device. In turn, the first terminal device transmits configuration information about the CO. In this way, other sidelink terminal device may multiplex resources in the CO based on the configuration information.

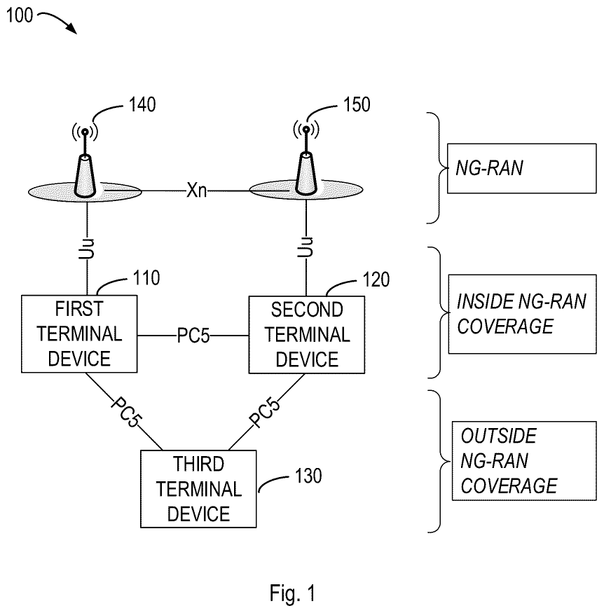

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

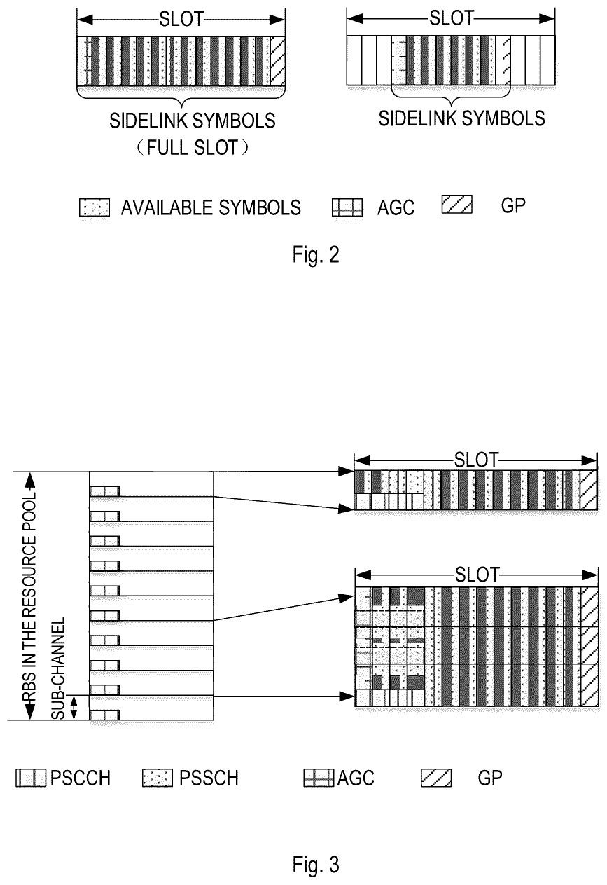

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The first terminal device 110, the second terminal device 120 and the third terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the first terminal device 110, the second terminal device 120 and the third terminal device 130 uses the PSSCH resource to send sidelink information, it can use one or more sub-channels to carry corresponding data information. A PSCCH resource includes t symbols in time domain, and k RBs in frequency domain. Each PSCCH channel resource is located at consecutive t symbols starting from the first symbol in the available symbols in the time domain, and located at the position of consecutive k RBs starting from the first RB in the corresponding sub-channel in the frequency domain, as shown in FIG. 3.

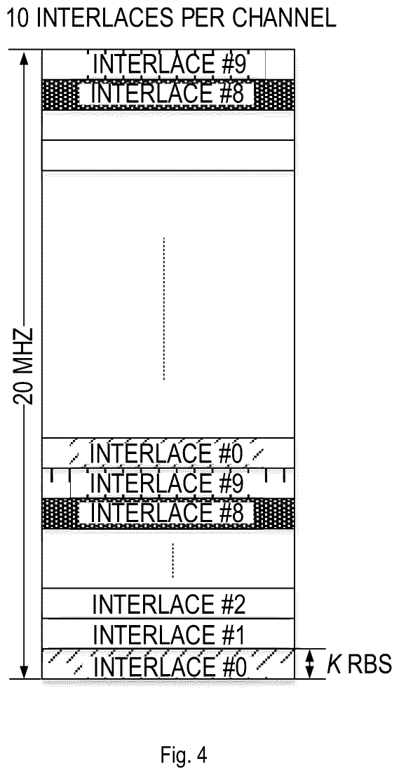

In order to satisfy the requirement of occupied channel bandwidth (OCB), interlace based RB allocation is used in unlicensed band in NR. An example of the structure of interlace is shown in FIG. 4. In FIG. 4, several non-consecutive PRBs are assigned as the resource of each interlace.

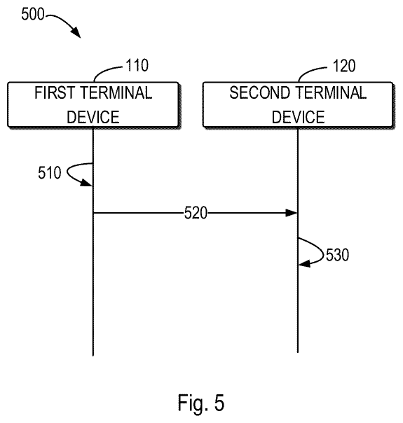

FIG. 5 illustrates an example signaling chart showing an example process 500 for CO sharing in accordance with some embodiments of the present disclosure. As shown in FIG. 5, the process 500 may involve the first terminal device 110 and the second terminal device 120 as shown in FIG. 1. It is to be understood that the process 500 may include additional acts not shown and/or may omit some acts as shown, and the scope of the present disclosure is not limited in this regard. In addition, it will be appreciated that, although primarily presented herein as being performed serially, at least a portion of the acts of the process 500 may be performed contemporaneously or in a different order than that presented in FIG. 5.

At shown in FIG. 5, the first terminal device 110 determines (510) CO for sidelink transmission. In turn, the first terminal device 110 transmits (520) the configuration information about the CO. Hereinafter, the configuration information about the CO will be also referred to as a sidelink CO structure.

Accordingly, the second terminal device 120 receives the configuration information about the CO from the first terminal device 110. In turn, the second terminal device 120 transmits (530) sidelink transmission in the CO based on the configuration information about the CO.

In some embodiments, the second terminal device 120 may transmit sidelink transmission in the CO to the first terminal device 110. In other embodiments, the second terminal device 120 may transmit sidelink transmission in the CO to other sidelink terminal device than the first terminal device 110. For example, the second terminal device 120 may transmit sidelink transmission in the CO to the third terminal device 130.

The process 500 provides a sidelink CO structure which can be shared among sidelink terminal devices, and it further supports sidelink transmission with variable length. More flexible and efficient resource using can be achieved by using the sidelink CO structure.

In some embodiments, within the CO, the first terminal device 110 may transmit at least one sidelink signal or sidelink channel.

In some embodiments, the sidelink transmission of the first terminal device 110 may include at least one of the following: SCI, data, channel state information (CSI), a positive acknowledge (ACK) or negative acknowledge (NACK) of sidelink, sidelink system synchronization block (SL-SSB), a discovery signal, PSCCH, PSSCH, PSFCH, PSBCH, or PSDCH.

In some embodiments, the configuration information about the CO may indicate a resource associated with the CO. In some embodiments, the configuration information about the CO may indicate the resource associated with the CO by indicating one of the following:
a duration of the sidelink transmission of the first terminal device 110,
the number of sidelink transmissions of the first terminal device 110 in the CO,
a duration of the CO, which is also referred to as COT,
a remain duration of the CO,
a resource used by the first terminal device 110,
a resource not used by the first terminal device 110 in the CO, or
an idle resource in the CO.

In embodiments where the first terminal device 110 performs a plurality of sidelink transmissions in the CO, the configuration information about the CO may indicate a duration of each of the sidelink transmissions or a total duration of the sidelink transmissions.

In some embodiments, the duration of the sidelink transmission of the first terminal device 110 or the duration of the CO may be indicated by the number of symbols, the number of slots, a combination of the number of slots and the number of symbols, or n ms.

In some embodiments, the resource used by the first terminal device 110 may comprise a resource in frequency domain. In such embodiments, the configuration information about the CO may indicate the resource used by the first terminal device 110 by at least one of the following: an index of a sub-channel used by the first terminal device 110, an index of an interlace used by the first terminal device 110, the number of sub-channels used by the first terminal device 110, or the number of interlaces used by the first terminal device 110.

Alternatively or additionally, the resource used by the first terminal device 110 may comprise a resource in time domain. In such embodiments, the configuration information about the CO may indicate the resource used by the first terminal device 110 by at least one of the following: a start symbol of the sidelink transmission of the first terminal device 110, or the number of symbols used for the sidelink transmission of the first terminal device 110.

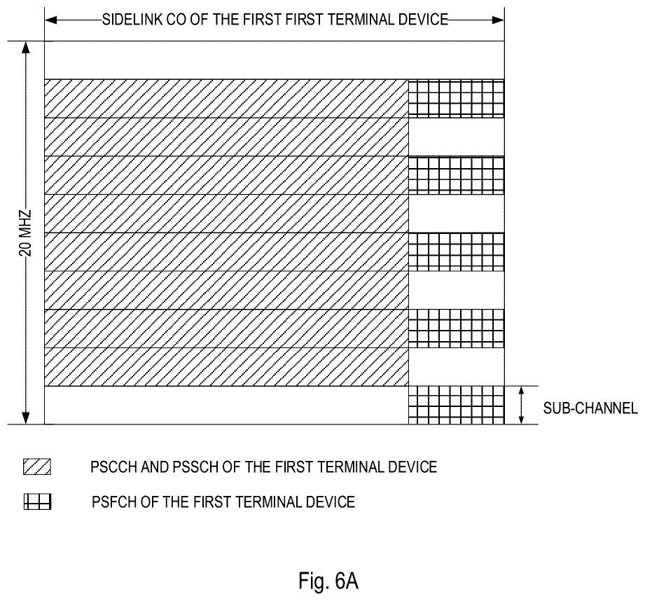

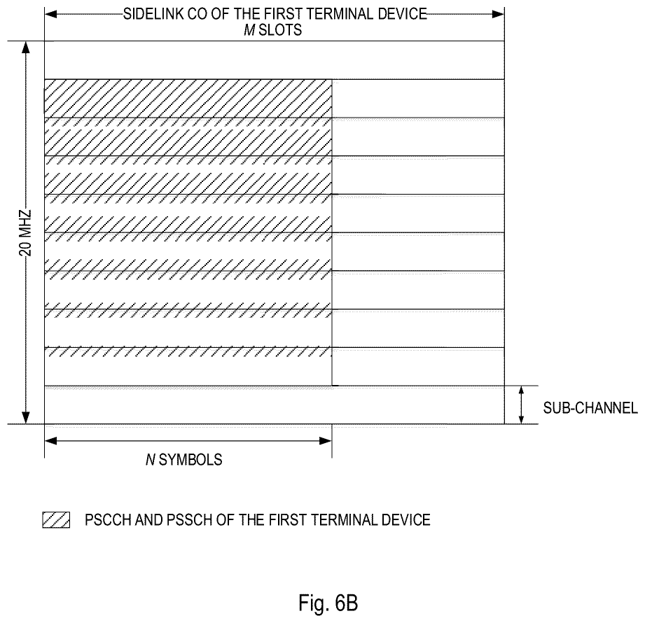

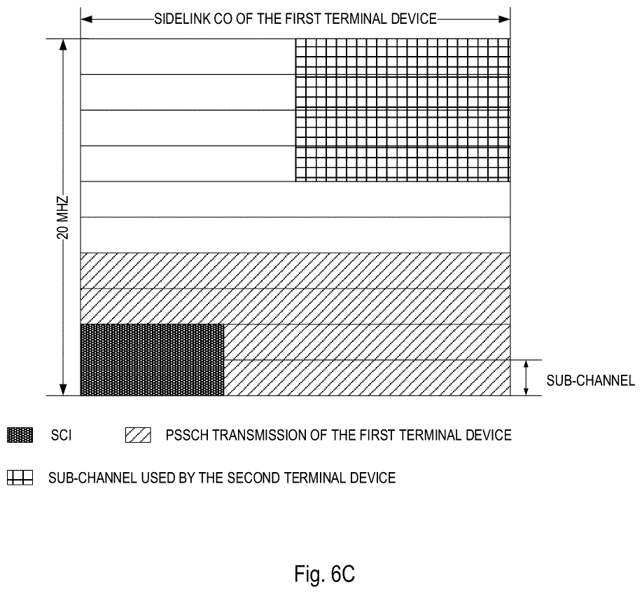

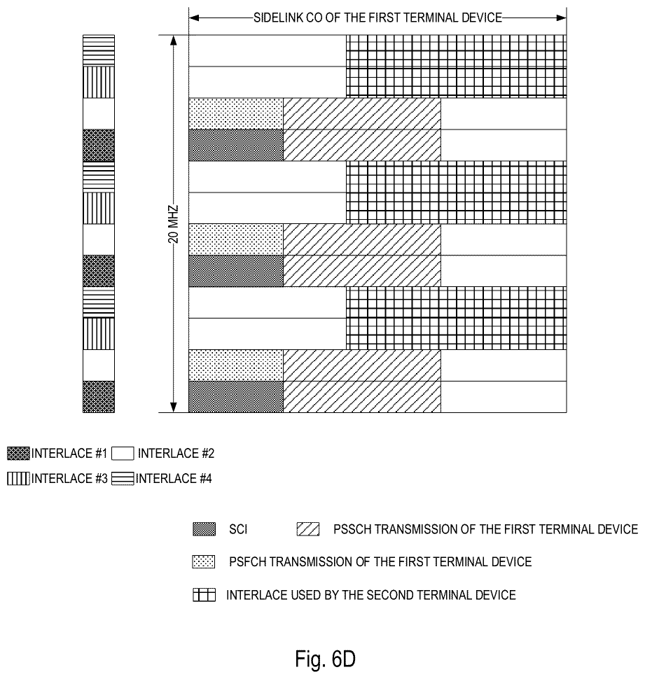

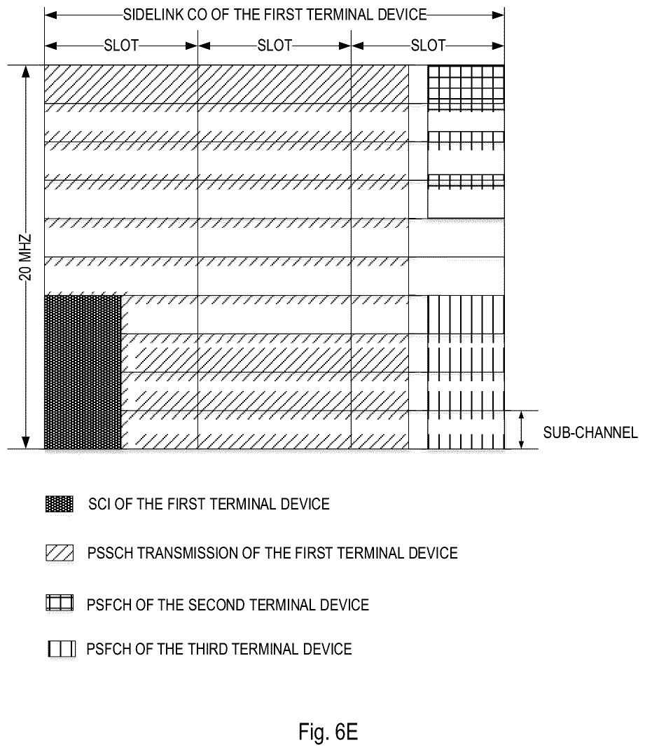

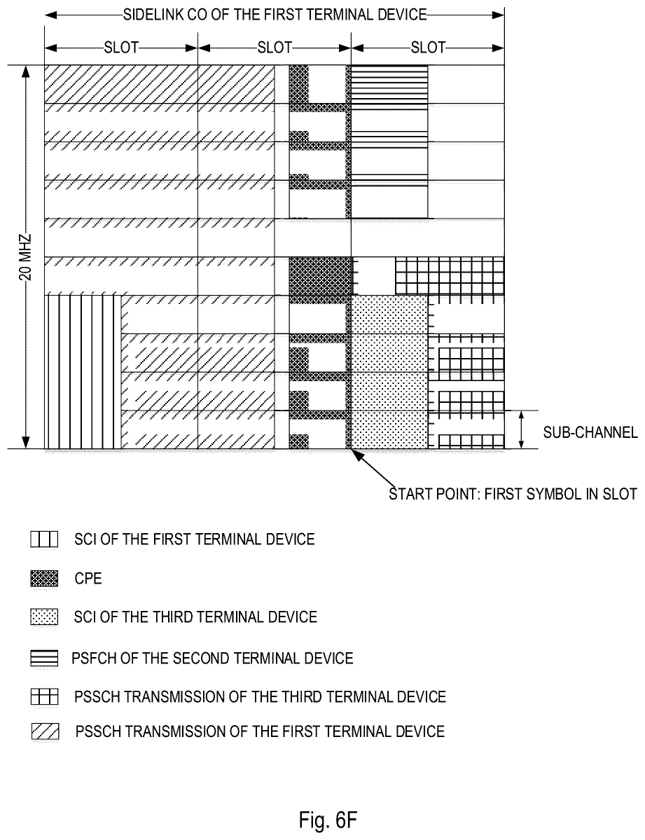

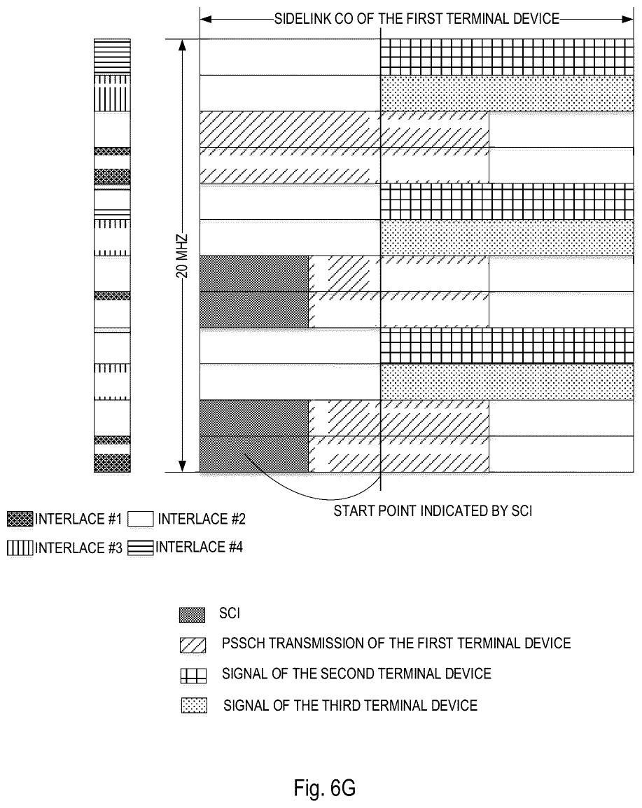

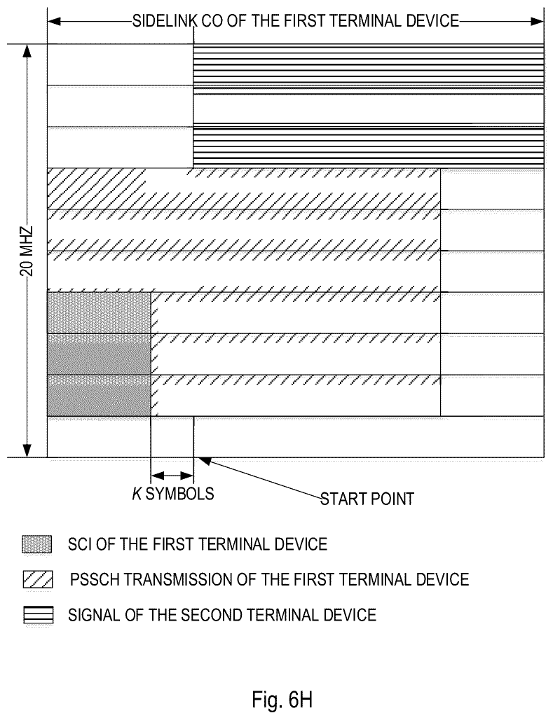

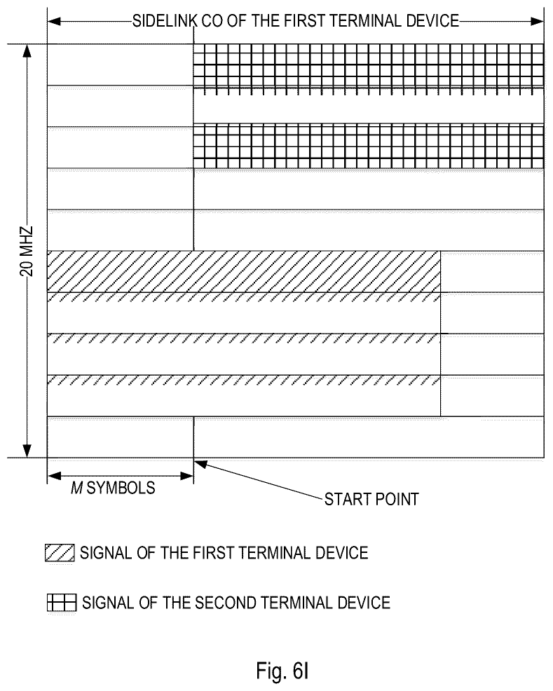

FIGS. 6A to 6I illustrate an example of CO sharing in accordance with some embodiments of the present disclosure, respectively.

In the example as shown in FIG. 6A, the first terminal device 110 transmits PSCCH or PSSCH as well as PSFCH in the CO. The first terminal device 110 indicates the resource used for its sidelink transmission, sub-channel allocation, a total duration of PSCCH or PSSCH as well as PSFCH by the number of symbols. The duration of the sidelink transmission of the first terminal device 110 is equal to the COT.

In the example as shown in FIG. 6B, the first terminal device 110 indicates the COT as m slots, and the duration of PSCCH and PSSCH as n symbols, where m and n are positive intergers.

In the example as shown in FIG. 6C, the COT is equal to the duration of PSSCH transmission. The COT is indicated by the number of symbols. The first terminal device 110 transmits a PSCCH and a PSSCH in the CO. The configuration information about the CO indicates the number and location of sub-channels used by the terminal device 110. The second terminal device 120 uses part of idle sub-channels (i.e. the sub-channels not used by the first terminal device) with the same end of the transmission of the first terminal device 110.

According to the configuration information about the CO, the second terminal device 120 may identify the resource not occupied by the first terminal device 110, and determine whether to perform its own transmission in the CO.

Because the COT is equal to the duration of PSSCH transmission of the first terminal device 110, the second terminal device 120 should end its transmission no later than the transmission of the first terminal device 110. In this way, the second terminal device may multiplex resources in the CO.

In the example as shown in FIG. 6D, the COT is indicated as n ms, where n is a positive integer. In frequency domain, resources in a CO are divided into several interlaces. The first terminal device 110 performs multiple sidelink transmissions in the CO. Specifically, within the CO, part of the interlaces are used by the first terminal device 110 as PSFCH, PSCCH and PSSCH. The transmissions of the first terminal device 110 may not extend to the end of the CO. The configuration information about the CO indicates indices of interlaces used by the first terminal device 110 and the duration of the transmissions of the first terminal device 110.

After decoding the configuration information about the CO, the second terminal device 120 may perform a type 2 clear channel assessment (CCA) and try to occupy the idle interlaces (i.e., the interlaces not used by the first terminal device) in the CO for its transmission.

In the example as shown in FIG. 6E, the first terminal device 110 uses more than one slot for sidelink transmission. In other words, the sidelink transmission of the first terminal device 110 crosses the slot boundary. The configuration information about the CO indicates the duration of the CO as 3 slots while the sidelink transmission of the first terminal device 110 uses 34 symbols (more than two slots). The configuration information about the CO may also indicate a remaining duration of the CO as the resource not used by the first terminal device in time domain, i.e., 8 symbols (the number of symbols contained in the CO minus the number of symbols used by the first terminal device).

After the transmission of the first terminal device 110, the second terminal device 120 and the third terminal device 130 may occupy the remained resources in the CO by using LBT procedure, respectively. The remained resources in time domain within the CO can be determined according to the COT and the duration of the sidelink transmission of the first terminal. In other words, the CO is shared in a TDM mode among the first terminal device 110, the second terminal device 120 and the third terminal device 130.

According to the configuration information about the CO and a pre-configured start point for sidelink transmission, the second terminal device 120 and the third terminal device 130 occupy different PSFCH resources to feed back sidelink ACK/NACK, respectively.

In some embodiments, in order to benefit receiving of a receiving terminal device, the second terminal device 120 should perform its transmission beginning from the next available start point for sidelink transmission. The start point should be a common understanding of all potential receiving terminal devices. Accordingly, a pre-configuration, a fixed rule or an explicit indication can be used to determine the available start point.

In some embodiments, a start point in time domain for sidelink transmission in the CO may be pre-configured.

In other embodiments, the start point in time domain for sidelink transmission in the CO may be determined based on the sidelink transmission of the first terminal device 110.

In still other embodiments, the start point in time domain for sidelink transmission in the CO may be determined as one of the following:
a first number of symbols after a start or end of the sidelink transmission of the first terminal device 110,
a second number of symbols from a start of the CO, or
a transmission gap after an end of the sidelink transmission of the first terminal device 110.

In some embodiments, the first number may be determined based on at least one of the following: the number of symbols used for the sidelink transmission of the first terminal device 110, processing time for decoding of the sidelink control information (SCI) comprising the configuration information, processing time for preparing sidelink transmission to be transmitted in the CO, a pre-configured value, or Subcarrier Spacing (SCS) used in the CO.

In some embodiments, the second number may be determined based on at least one of the following: the number of symbols used for the sidelink transmission of the first terminal device 110, processing time for decoding of sidelink control information (SCI) comprising the configuration information, processing time for preparing sidelink transmission to be transmitted in the CO, a pre-configured value, or Subcarrier Spacing (SCS) used in the CO.

Hereinafter, examples of a start point for sidelink transmission in the CO will be described with reference to FIGS. 6F, 6G, 6H and 6I.

In the example as shown in FIG. 6F, the configuration information about the CO indicates the duration of the current CO as 3 slots and sidelink transmission of the first terminal device 110 uses 20 symbols.

The potential start point of sidelink transmission is pre-configured as the first symbol of each slot, then the next available start point is the first symbol of the third slot in the CO. As the end of transmission of the first terminal device 110 is in the middle of the second slot, the second terminal device 120 and the third terminal device 130 should transmit respective effective signal from the next available start point, i.e., the first symbol in the third slot. Before that, the second terminal device 120 and the third terminal device 130 should send cyclic prefix extension (CPE) signals before their actual transmissions to maintain the channel occupancy.

In the CO, each of the second terminal device 120 and the third terminal device 130 may transmit at least one of following: sidelink control signal, sidelink data signal, ACK or NACK of sidelink transmission, sidelink CSI signal, SL-SSB, or sidelink discovery signal. For example, as shown in FIG. 6F, the second terminal device 120 transmits sidelink ACK/NACK on PSFCH, and the third terminal device 130 transmits SCI on PSCCH and data on PSSCH.

In the example as shown in FIG. 6G, the configuration information about the CO indicates the interlaces used by the first terminal device 110 and an allowed start point of current CO, and the second terminal device 120 and the third terminal device 130 should perform transmission according to the configuration information about the CO.

As shown in FIG. 6G, the indicated start point is before the end of the sidelink transmission of the first terminal device 110, and the second terminal device 120 and the third terminal device 130 do not need to send CPE before the start point.

In the CO, each of the second terminal device 120 and the third terminal device 130 may transmit at least one of following: sidelink control signal, sidelink data signal, ACK or NACK of sidelink transmission, sidelink CSI signal, SL-SSB, or sidelink discovery signal. For example, as shown in FIG. 6G, the second terminal device 120 transmits sidelink transmission by using interlace #4, and the third terminal device 130 transmits sidelink transmission by using interlace #3.

In the example as shown in FIG. 6H, the start point is determined as the first number of symbols after an end of PSCCH transmission of the first terminal device 110. The first number is represented by K, where K is a pre-configured positive integer.

In the example as shown in FIG. 6I, the start point is determined as the second number of symbols from a start of the CO. The second number is represented by M, where M is a positive integer, and determined according to the number of symbols used for PSCCH and the processing time for decoding the SCI contained in the PSCCH.

In some embodiments, in order to further manage the sidelink COT sharing, the configuration information about the CO may indicate other information than the resource associated with the CO.

In some embodiments, the configuration information about the CO may indicate a flag indicating whether the CO is allowed to be shared. For example, the flag may comprise an indicator of one bit. For another example, the flag may comprise a preamble signal transmitted by the first terminal device 110 at a start of the CO. In other words, a dedicated sequence transmitted by the first terminal device 110 means COT sharing is allowed.

By using the flag indicating whether the CO is allowed to be shared, the first terminal device 110 can control the CO to be a dedicated resource for itself or may be shared with other terminal devices.

In some embodiments, the configuration information about the CO may indicate a priority threshold for the sidelink transmission in the CO. In such embodiments, if the second terminal device 120 would like to share the CO, the priority of sidelink transmission of the second terminal device 120 should be higher than or equal to the priority threshold.

In other embodiments, the configuration information about the CO may indicate a priority of the sidelink transmission of the first terminal device 110. The priority may be Channel Access Priority Class (CAPC) used by the first terminal device in an LBT procedure to initiate the CO. In such embodiments, if the second terminal device 120 would like to share the CO, the priority of sidelink transmission of the second terminal device 120 should be higher than or equal to the CAPC of the first terminal device.

By setting the priority threshold for sharing a CO determined by the first terminal device 110, and the possibility of resource collision between the second terminal device 120 and the third terminal device 130 may be decreased.

In addition, according to the priority threshold or the priority of the sidelink transmission of the first terminal device 110, the second terminal device 120 should determine whether the idle resource in a CO can be used for its transmission.

In some embodiments, the configuration information about the CO may indicate a type of a sidelink signal, sidelink transmission, or sidelink channel which is allowed to be transmitted in the CO.

In other embodiments, the configuration information about the CO may indicate a type of a sidelink signal, sidelink transmission, or sidelink channel which is not allowed to be transmitted in the CO.

In some embodiments, the sidelink signal which is allowed or not allowed to be transmitted in the CO may comprise at least one of the following: sidelink control signal, sidelink data signal, positive acknowledge (ACK) or negative acknowledge (NACK) of sidelink transmission, sidelink Channel-state information (CSI) signal, sidelink system synchronization block (SL-SSB), or sidelink discovery signal.

In some embodiments, the sidelink transmission which is allowed or not allowed to be transmitted in the CO may comprise at least one of the following: sidelink unicast transmission, sidelink groupcast transmission, or sidelink broadcast transmission.

In some embodiments, the sidelink channel which is allowed or not allowed to be transmitted in the CO may comprise at least one of the following: PSCCH, PSSCH, PSFCH, PSBCH, or PSDCH.

By indicating the type of a sidelink signal, sidelink transmission, or sidelink channel which is allowed or not allowed to be transmitted in the CO, the first terminal device 110 may manage the usage of resource for different types of sidelink communication.

In some embodiments, the configuration information about the CO may indicate a type of CCA which is allowed to be performed in the CO. For example, the type of the CCA may comprise at least one of the following: a type 2A of CCA, a type 2B of CCA, or a type 2C of CCA. In other words, the second terminal device 120 may use a type 2A of CCA, a type 2B of CCA, or a type 2C of CCA to occupy the idle resource in the CO.

As defined in NR-U, the type 2A of CCA means a terminal device should sensing a channel for 25 μs. If the channel is idle, the terminal device can access the channel and transmit signal. The type 2B of CCA requires 16 μs sensing and the type 2C of CCA requires no sensing.

By indicating the allowed type of CCA, the first terminal device 110 may manage the transmissions within a CO.

Alternatively, the type of CCA which is allowed to be performed in the CO may be pre-configured.

In some embodiments, the resource sharing in SL-U CO may be Frequency Division Multiplex (FDM) between the first terminal device 110 and the second terminal device 120. In other words, the first terminal device 110 may be unable to receive signal from the second terminal device 120 considering the half-duplexing issue, and vice versa. To avoid a target transmitting terminal device or receiving terminal device acting as the second terminal device 120 in the CO, the first terminal device 110 can preclude the related terminal device from sharing the resource.

In such embodiments, the configuration information about the CO may indicate a sidelink terminal device which is not allowed to use a resource in the CO.

In some embodiments, the sidelink terminal device which is not allowed to use the resource in the CO may comprise at least one of the following:
a terminal device which performs sidelink unicast transmission with the first terminal device 110,
a terminal device which belongs to a group comprising the first terminal device,
a terminal device which locates in a zone indicated by the first terminal device,
a terminal device which locates within an indicated distance from the first terminal device,
a terminal device from which the first terminal device receives a signal,
a terminal device which is a target terminal device for receiving the sidelink transmission of the first terminal device, or
a terminal device which receives the signal strength of the sidelink transmission of the first terminal device exceeds a strength threshold.

For sidelink communication, the first terminal device 110 may perform unicast, groupcast or broadcast with one or more terminal devices. Within a CO determined by the first terminal device 110, for the case that the second terminal device 120 may transmit on idle resources before the end of transmission of the first terminal device 110, a target transmitting terminal device or receiving terminal device for the first terminal device 110 should not share the resource. In other words, the sidelink terminal device which is not allowed to use the resource in the CO may comprise at least one of the following: a terminal device from which the first terminal device 110 receives a signal, or a terminal device which is a target terminal device for receiving the sidelink transmission of the first terminal device 110.

In such embodiments, the configuration information may indicate the sidelink terminal device which is not allowed to use the resource in the CO by indicating at least one of the following: an identification (ID) of the sidelink terminal device, or a type of the sidelink terminal device.

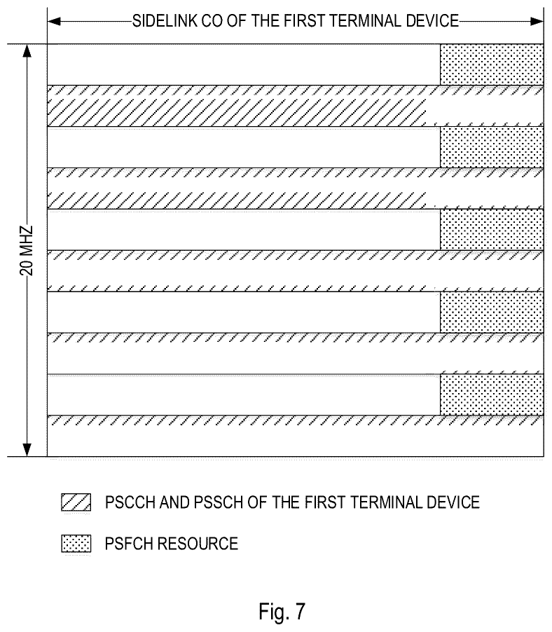

For example, the first terminal device 110 may indicate ID of the sidelink terminal device in SCI as a black list, or assign the type of the terminal device which is not allowed to use a resource in the CO through PC5 RRC signaling. Besides the terminal device which contains unicast with the first terminal device 110, one or more terminal devices belonging to a same sidelink group with the first terminal device 110 may be identified as terminal devices which are not allowed to use a resource in the CO, and a group ID may be used to mark the black list. This will be described with reference to FIG. 7.

FIG. 7 illustrates an example of CO sharing in accordance with some other embodiments of the present disclosure.

In the example as shown in FIG. 7, the first terminal device 110 performs unicast transmission with the second terminal device 120, and configures the second terminal device 120 to feed back ACK/NACK to it. The ACK/NACK signal should be sent by the second terminal device 120 and detected by the first terminal device 110. Then the second terminal device 120 should not use PSFCH resource which may not be received by the first terminal device 110. Accordingly, the first terminal device 110 indicates the second terminal device 120 in a black list.

In some embodiments, for TDM between the first terminal device 110 and the second terminal device 120 in a CO, the first terminal device 110 may manage the resource shared by a target terminal device, e.g., a terminal device which may have sidelink communication with it, or a terminal device which is adjacent to the first terminal device 110.

In such embodiments, the configuration information may indicate the sidelink terminal device which is allowed to use the resource in the CO. This may benefit resource efficiency and decrease interference.

In some embodiments, the sidelink terminal device which is allowed to use the resource in the CO may comprise at least one of the following:
a terminal device which performs sidelink unicast transmission with the first terminal device 110,
a terminal device which belongs to a group comprising the first terminal device 110,
a terminal device which locates in a zone indicated by the first terminal device 110,
a terminal device which locates within an indicated distance from the first terminal device 110,
a terminal device from which the first terminal device receives a signal,
a terminal device which is a target terminal device for receiving the sidelink transmission of the first terminal device, or
a terminal device which receives the signal strength of the sidelink transmission of the first terminal device exceeds a strength threshold.

In some embodiments, the signal strength of the sidelink transmission may be represented by Reference Signal Received Power (RSRP) or Reference Signal Received Quality (RSRQ).

In such embodiments, the configuration information may indicate the sidelink terminal device which is allowed to use the resource in the CO by indicating at least one of the following: an ID of the sidelink terminal device, or a type of the sidelink terminal device, an ID of the zone, or a distance threshold.

For example, the first terminal device 110 may indicate the sidelink terminal device which is allowed to use the resource in the CO as one of the following:
a terminal device which performs sidelink unicast transmission with the first terminal device 110, by indicating ID of the terminal device;
a terminal device in the same group with the first terminal device 110 by indicating group ID;
a terminal device in a specific zone by indicating ID of the zone; for example, the same zone with the first terminal device 110 (it helps to ensure the second terminal device with similar channel status with the first terminal device 110), or an adjacent zone of the first terminal device 110 (it may benefit interference control);
a terminal device adjacent to the first terminal device 110 by indicating a distance threshold; or
a terminal device which detects the SCI of the first terminal device 110, and the RSRP or RSRQ of the received SCI exceeds a corresponding threshold, wherein the threshold of RSRP or RSRQ should be configured, pre-configured or indicated by the first terminal device 110.

In some embodiments, for sidelink unicast transmission, the first terminal device 110 may schedule a sidelink terminal device in the CO. In such embodiments, the sidelink terminal device may be referred to as a pair terminal device which implements sidelink unicast transmission with the first terminal device 110. In such embodiments, the configuration information about the CO comprises scheduling information for the pair sidelink terminal device. For example, the scheduling information indicates a resource in the CO assigned to the pair sidelink terminal device for performing sidelink unicast transmission to the first terminal device 110. The pair terminal device should transmit a signal according to the scheduling information. In this way, the first terminal device 110 can accurately control the resource in a CO and service the pair terminal device.

In some embodiments, for sidelink groupcast transmission, the first terminal device 110 may schedule at least one member terminal device in the CO. In such embodiments, the first terminal device 110 acts as a manage node, i.e., roadside unit (RSU) or header terminal device, to schedule at least one member terminal device in a group. The group comprises the first terminal device 110.

In the embodiments for sidelink groupcast transmission, the configuration information about the CO comprises scheduling information for the at least one member terminal device. For example, the scheduling information indicates a resource in the CO assigned to the at least one member terminal device for performing sidelink groupcast transmission to the first terminal device 110. In this way, the first terminal device 110 can accurately control the resource in a CO and service the at least one member terminal device.

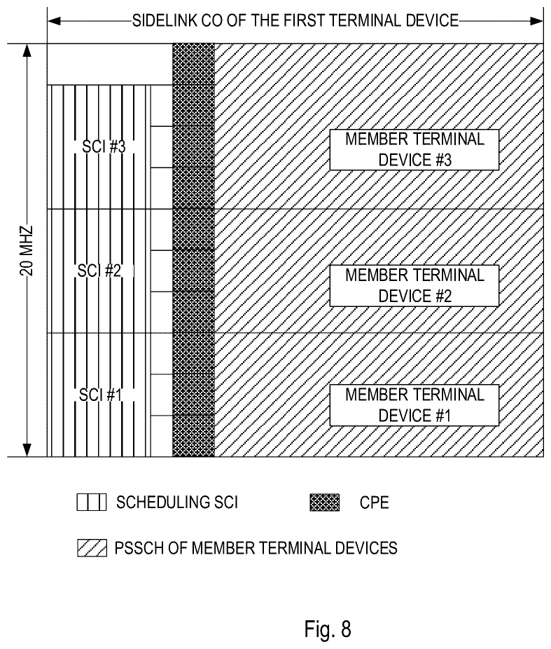

In such embodiments, one or more pieces of SCI should be used by the first terminal device 110 to indicate the resource assigned to the at least one member terminal device. This will be described with reference to FIG. 8.

FIG. 8 illustrates an example of CO sharing in accordance with still other embodiments of the present disclosure. In the example as shown in FIG. 8, the first terminal device 110 is a group header node and has the management authority of the group. In the CO determined by the first terminal device 110, the first terminal device 110 sends SCI #1, SCI #2 and SCI #3 to schedule a member terminal device #1, a member terminal device #2 and a member terminal device #3 within the CO, respectively. In detail, each of the SCI #1, SCI #2 and SCI #3 indicates the resource grant for a respective member terminal device, and the member terminal devices #1, #2 and #3 start transmissions from the same symbol.

In some embodiments, the first terminal device 110 may transmit the configuration information about the CO by transmitting at least one piece of SCI comprising the configuration information.

In some embodiments, the first terminal device 110 may transmit first SCI which comprises a first subset of the configuration information.

In some embodiments, the first subset of the configuration information may at least indicate the resource associated with the CO.

In some embodiments, the first SCI may further indicate at least one of the following:
the start point in time domain for sidelink transmission in the CO,
the flag indicating whether the CO is allowed to be shared,
the priority threshold for the sidelink transmission in the CO,
the priority of the sidelink transmission of the first terminal device 110,
the type of a sidelink signal which is allowed to be transmitted in the CO,
the type of a sidelink signal which is unallowed to be transmitted in the CO,
the type of sidelink transmission which is allowed to be transmitted in the CO,
the type of sidelink transmission which is unallowed to be transmitted in the CO,
the type of a sidelink channel which is allowed to be transmitted in the CO,
the type of a sidelink channel which is unallowed to be transmitted in the CO,
the type of clear channel assessment (CCA) which is allowed to be performed in the CO,
the sidelink terminal device which is allowed to use a resource in the CO,
the sidelink terminal device which is unallowed to use a resource in the CO,
the type of the sidelink transmission of the first terminal device 110, or
scheduling information for at least one sidelink terminal device.

In some embodiments, the first terminal device 110 may transmit second SCI which comprises a second subset of the configuration information. For example, the second subset may be different from the first subset. In other words, there may be no overlap between the first SCI and the second SCI.

In some embodiments, the second SCI may indicate at least one of the following:
the start point in time domain for sidelink transmission in the CO,
the flag indicating whether the CO is allowed to be shared,
the priority threshold for the sidelink transmission in the CO,
the priority of the sidelink transmission of the first terminal device 110,
the type of a sidelink signal which is allowed to be transmitted in the CO,
the type of a sidelink signal which is unallowed to be transmitted in the CO,
the type of sidelink transmission which is allowed to be transmitted in the CO,
the type of sidelink transmission which is unallowed to be transmitted in the CO,
the type of a sidelink channel which is allowed to be transmitted in the CO,
the type of a sidelink channel which is unallowed to be transmitted in the CO,
the type of clear channel assessment (CCA) which is allowed to be performed in the CO,
the sidelink terminal device which is allowed to use a resource in the CO,
the sidelink terminal device which is unallowed to use a resource in the CO,
the type of the sidelink transmission of the first terminal device 110, or
scheduling information for at least one sidelink terminal device.

In some embodiments, the first terminal device 110 may transmit third SCI which comprises the scheduling information.

In some embodiments, the first SCI may indicate at least one of the following: presence of the second SCI, a format of the second SCI, presence of the third SCI, a format of the third SCI.

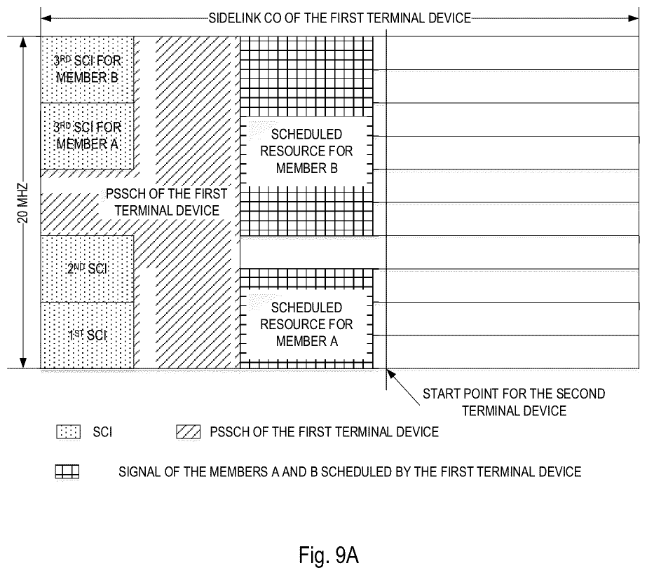

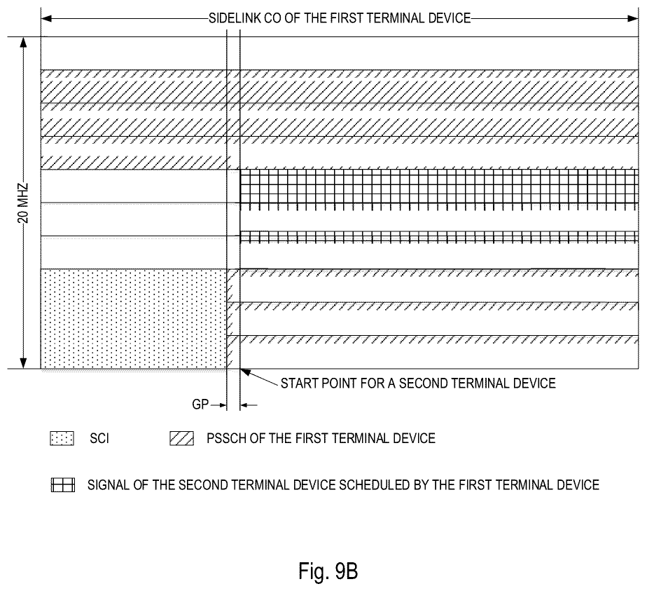

Using respective SCI formats for different purposes make easy to control the overhead of each SCI, and it further benefits the SCI detecting and decoding. This will be described with reference to FIG. 9A.

FIG. 9A illustrates an example of CO sharing in accordance with still other embodiments of the present disclosure. In the example as shown in FIG. 9A, the first terminal device 110 is a group header node, and it assigns three types of SCI to assign the relevant information of the CO.

As shown in FIG. 9A, first SCI contains legacy indicators of PSSCH, and also indicates that a second SCI and a third SCI are also presented in this CO. Configuration information about current CO is assigned in the second SCI, which includes CO sharing flag, a priority threshold for the CO and a start point for sidelink transmission of the second terminal device 120. Besides, there are two pieces of the third SCI which schedule member terminal devices A and B to report ACK/NACK or CSI. In FIG. 9A, for brevity, the member terminal devices A and B are referred to as members A and B, respectively.

Based on the configuration information about the current CO, the second terminal device 120 may determine the start point for sidelink transmission. In turn, the second terminal device 120 may transmit a signal beginning from the start point.

In some embodiments, symbols used for SCI comprising the configuration information about the CO may be fixed number of symbols, configured or pre-configured.

In other embodiments, symbols used for SCI comprising the configuration information about the CO may be variable number of symbols. For example, the SCI may start from the beginning of the CO, or start from a start point of sidelink transmission (common start point). For another example, the SCI may end before next available start point, may be a guard period (GP) before the next start point which is related to SCI decoding time+0/5/16//25 μs. This will be described with reference to FIG. 9B.

In some embodiments, a frequency resource for SCI comprising the configuration information about the CO may be configured so that one piece of SCI is carried within one sub-channel or interlace. In other embodiments, a frequency resource for SCI comprising the configuration information about the CO may be configured so that one piece of SCI is carried on multiple consecutive sub-channels or interlaces (logical consecutive index). In this way, the resource for SCI in a CO may be clarified, which may be essential for a terminal device to detect and decode SCI.

FIG. 9B illustrates an example of CO sharing in accordance with still other embodiments of the present disclosure. In the example as shown in FIG. 9B, the SCI transmission begins from a start point of sidelink transmission which is also the boundary of the CO, and ends before the next available start point of sidelink transmission. In order to maintain a duration for SCI decoding, sensing, or Tx/Rx status switching, the length of GP between the end of SCI and the next start point may be set as 25 μs.

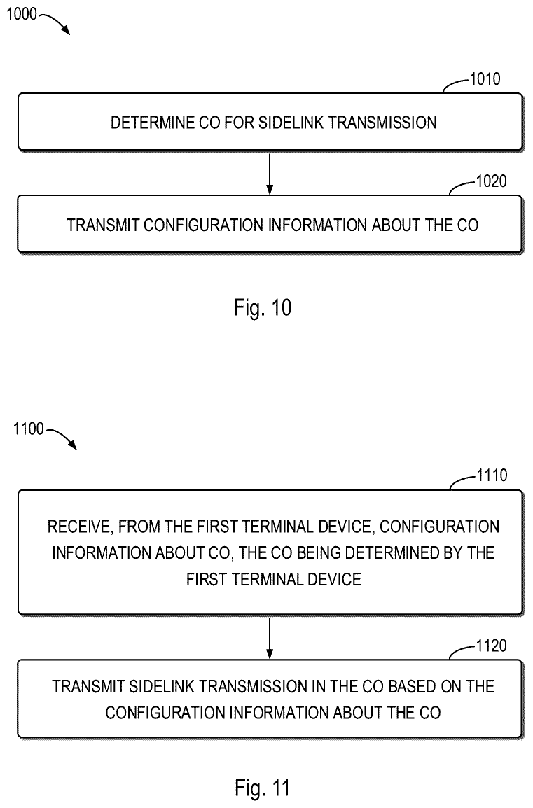

FIG. 10 illustrates a flowchart of an example method 1000 in accordance with some embodiments of the present disclosure. In some embodiments, the method 1000 can be implemented at a terminal device, such as the first terminal device 110 as shown in FIG. 1. For the purpose of discussion, the method 1000 will be described with reference to FIG. 1 as performed by the first terminal device 110 without loss of generality.

At block 1010, the first terminal device 110 determines CO for sidelink transmission. At block 1020, the first terminal device 110 transmits the configuration information about the CO.

In some embodiments, the configuration information may indicate at least one of the following: a resource associated with the CO, a start point in time domain for sidelink transmission in the CO, a flag indicating whether the CO is allowed to be shared, a priority threshold for the sidelink transmission in the CO, a priority of the sidelink transmission of the first terminal device, a type of a sidelink signal which is allowed to be transmitted in the CO, a type of a sidelink signal which is unallowed to be transmitted in the CO, a type of sidelink transmission which is allowed to be transmitted in the CO, a type of sidelink transmission which is unallowed to be transmitted in the CO, a type of a sidelink channel which is allowed to be transmitted in the CO, a type of a sidelink channel which is unallowed to be transmitted in the CO, a type of clear channel assessment (CCA) which is allowed to be performed in the CO, a sidelink terminal device which is allowed to use a resource in the CO, a sidelink terminal device which is unallowed to use a resource in the CO, a type of the sidelink transmission of the first terminal device, or scheduling information for at least one sidelink terminal device.

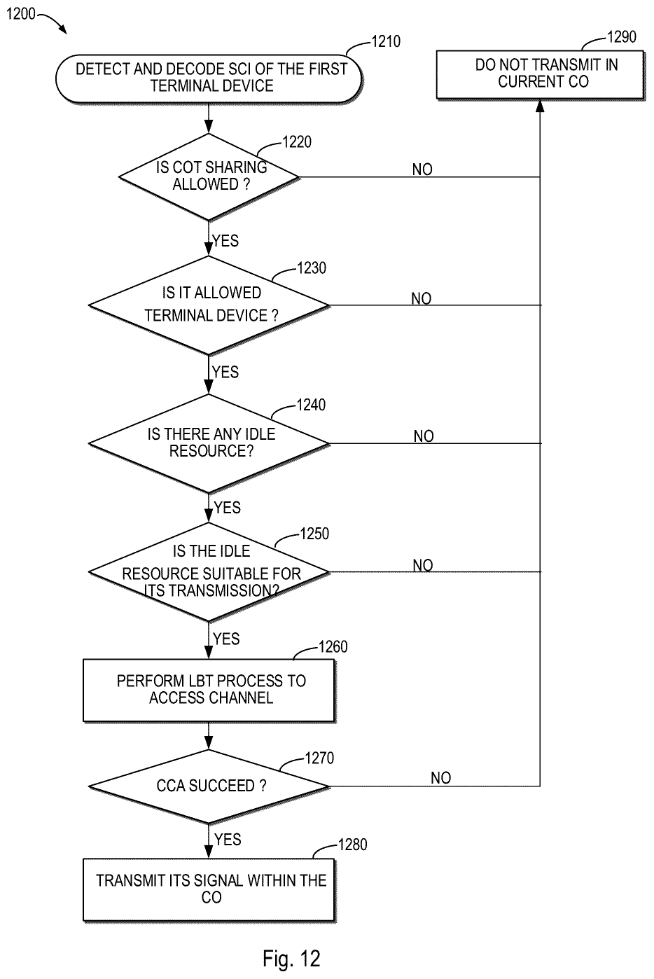

It should be understood that the configuration information may indicate any combination of two or more items as described above. For example, the configuration information may indicate the resource used by the first terminal device 110 and the start point, as described with reference to FIG. 6G. For example, the configuration information may indicate the flag indicating whether the CO is allowed to be shared, the priority threshold for the sidelink transmission in the CO, and the start point, as described with reference to FIG. 9A. For example, the configuration information may indicate the flag indicating whether the CO is allowed to be shared, the sidelink terminal device which is allowed to use a resource in the CO, and the resource associated with the CO, as described with reference to FIG. 12.

It should be also understood that the above combinations of the items indicated by the configuration information are just described for example, and any other combinations of items may be implemented in the present disclosure.

In some embodiments, the configuration information may indicate the resource associated with the CO by indicating at least one of the following: a duration of the sidelink transmission of the first terminal device, the number of sidelink transmissions of the first terminal device in the CO, a duration of the CO, a remaining duration of the CO, a resource used by the first terminal device, a resource not used by the first terminal device in the CO, or an idle resource in the CO.

In some embodiments, the configuration information may indicate the resource used by the first terminal device by at least one of the following: an index of a sub-channel used by the first terminal device, an index of an interlace used by the first terminal device, the number of sub-channels or interlaces used by the first terminal device, a start symbol of the sidelink transmission of the first terminal device, or the number of symbols used for the sidelink transmission of the first terminal device.

In some embodiments, the symbols used for the sidelink transmission of the first terminal device are included in a plurality of consecutive slots.

In some embodiments, a start point in time domain for sidelink transmission in the CO is pre-configured.

In some embodiments, a start point in time domain for sidelink transmission in the CO is determined based on sidelink transmission of the first terminal device.

In some embodiments, the start point is determined as one of the following: a first number of symbols after a start or end of the sidelink transmission of the first terminal device, a second number of symbols from a start of the CO, or a transmission gap after an end of the sidelink transmission of the first terminal device.

In some embodiments, the first number is determined based on at least one of the following: the number of symbols used for the sidelink transmission of the first terminal device, processing time for decoding of sidelink control information (SCI) comprising the configuration information, processing time for preparing sidelink transmission to be transmitted in the CO, a pre-configured value, or Subcarrier Spacing (SCS) used in the CO.

In some embodiments, the second number is determined based on at least one of the following: the number of symbols used for the sidelink transmission of the first terminal device, processing time for decoding of sidelink control information (SCI) comprising the configuration information, processing time for preparing sidelink transmission to be transmitted in the CO, a pre-configured value, or Subcarrier Spacing (SCS) used in the CO.

In some embodiments, the flag comprise one of the following: an indicator of one bit, or a preamble signal transmitted by the first terminal device at a start of the CO.

In some embodiments, the type of the sidelink signal comprises at least one of the following: sidelink control signal, sidelink data signal, positive acknowledge or negative acknowledge of sidelink transmission, sidelink Channel-state information signal, sidelink system synchronization block, or sidelink discovery signal.

In some embodiments, the type of the sidelink transmission comprises at least one of the following: sidelink unicast transmission, sidelink groupcast transmission, or sidelink broadcast transmission.

In some embodiments, the type of the sidelink channel comprises at least one of the following: physical sidelink control channel, physical sidelink shared channel, physical sidelink feedback channel, physical sidelink broadcast channel, or physical sidelink discovery channel.

In some embodiments, the type of the CCA comprises at least one of the following: a type 2A of CCA, a type 2B of CCA, or a type 2C of CCA.

In some embodiments, the configuration information may indicate a sidelink terminal device which is allowed or unallowed to use the resource in the CO by indicating at least one of the following: an identification of the sidelink terminal device, or a type of the sidelink terminal device.

In some embodiments, the type of the sidelink terminal device which is allowed or unallowed to use the resource in the CO comprises at least one of the following: a terminal device which performs sidelink unicast transmission with the first terminal device, a terminal device which belongs to a group comprising the first terminal device, a terminal device which locates in a zone indicated by the first terminal device, a terminal device which locates within an indicated distance from the first terminal device, a terminal device from which the first terminal device receives a signal, a terminal device which is a target terminal device for receiving the sidelink transmission of the first terminal device, or a terminal device which receives the signal strength of the sidelink transmission of the first terminal device exceeds a strength threshold.

In some embodiments, the signal strength of the sidelink transmission comprises at least one of the following: Reference Signal Receiving Power (RSRP), or Reference Signal Receiving Quality (RSRQ).

In some embodiments, the configuration information indicates the scheduling information for at least one sidelink terminal device by indicating at least one of the following: a resource assigned to a sidelink terminal device for performing sidelink unicast transmission to the first terminal device, or a resource assigned to at least one sidelink terminal device for performing sidelink groupcast transmission in a group, wherein the group comprising the first terminal device.

In some embodiments, the first terminal device 110 may transmit the configuration information by transmitting at least one piece of sidelink control information (SCI) comprising the configuration information.

In some embodiments, the first terminal device 110 may transmit first SCI which comprises at least the resource associated with the CO.

In some embodiments, the first terminal device 110 may transmit second SCI which comprises at least one of the following: the start point in time domain for sidelink transmission in the CO, the flag indicating whether the CO is allowed to be shared, the priority threshold for the sidelink transmission in the CO, the priority of the sidelink transmission of the first terminal device, the type of the sidelink signal which is allowed to be transmitted in the CO, the type of the sidelink signal which is unallowed to be transmitted in the CO, the type of sidelink transmission which is allowed to be transmitted in the CO, the type of sidelink transmission which is unallowed to be transmitted in the CO, the type of the sidelink channel which is allowed to be transmitted in the CO, the type of the sidelink channel which is unallowed to be transmitted in the CO, the type of clear channel assessment (CCA) which is allowed to be performed in the CO, the sidelink terminal device which is allowed to use a resource in the CO, the sidelink terminal device which is unallowed to use a resource in the CO, the type of the sidelink transmission of the first terminal device, or the scheduling information for at least one sidelink terminal device.

In some embodiments, the first terminal device 110 may transmit the configuration information by transmitting third SCI which at least comprises the scheduling information.

In some embodiments, the first SCI indicates at least one of the following: presence of the second SCI or a format of the second SCI.

In some embodiments, the first SCI indicates at least one of the following: presence of the third SCI, or a format of the third SCI.

FIG. 11 illustrates a flowchart of an example method 1100 in accordance with some embodiments of the present disclosure. In some embodiments, the method 1100 can be implemented at a terminal device, such as the second terminal device 120 as shown in FIG. 1. For the purpose of discussion, the method 1100 will be described with reference to FIG. 1 as performed by the second terminal device 120 without loss of generality.

At block 1110, the second terminal device 120 receives, from the first terminal device 110, configuration information about CO for sidelink transmission. The CO is determined by the first terminal device 110.

At block 1120, the second terminal device 120 transmits sidelink transmission in the CO based on the configuration information about the CO.

In some embodiments, the configuration information may indicate at least one of the following: a resource associated with the CO, a start point in time domain for sidelink transmission in the CO, a flag indicating whether the CO is allowed to be shared, a priority threshold for the sidelink transmission in the CO, a priority of the sidelink transmission of the first terminal device, a type of a sidelink signal which is allowed to be transmitted in the CO, a type of a sidelink signal which is unallowed to be transmitted in the CO, a type of sidelink transmission which is allowed to be transmitted in the CO, a type of sidelink transmission which is unallowed to be transmitted in the CO, a type of a sidelink channel which is allowed to be transmitted in the CO, a type of a sidelink channel which is unallowed to be transmitted in the CO, a type of clear channel assessment (CCA) which is allowed to be performed in the CO, a sidelink terminal device which is allowed to use a resource in the CO, a sidelink terminal device which is unallowed to use a resource in the CO, a type of the sidelink transmission of the first terminal device, or scheduling information for at least one sidelink terminal device.

In some embodiments, the configuration information may indicate the resource associated with the CO by indicating at least one of the following: a duration of the sidelink transmission of the first terminal device, the number of sidelink transmissions of the first terminal device in the CO, a duration of the CO, a remain duration of the CO, a resource used by the first terminal device, a resource not used by the first terminal device in the CO, or an idle resource in the CO.

In some embodiments, the configuration information may indicate the resource used by the first terminal device by at least one of the following: an index of a sub-channel used by the first terminal device, an index of an interlace used by the first terminal device, the number of sub-channels or interlaces used by the first terminal device, a start symbol of the sidelink transmission of the first terminal device, or the number of symbols used for the sidelink transmission of the first terminal device.

In some embodiments, the symbols used for the sidelink transmission of the first terminal device are included in a plurality of consecutive slots.

In some embodiments, a start point in time domain for sidelink transmission in the CO is pre-configured.

In some embodiments, a start point in time domain for sidelink transmission in the CO is determined based on sidelink transmission of the first terminal device.

In some embodiments, the start point is determined as one of the following: a first number of symbols after a start or end of the sidelink transmission of the first terminal device, a second number of symbols from a start of the CO, or a transmission gap after an end of the sidelink transmission of the first terminal device.

In some embodiments, the first number is determined based on at least one of the following: the number of symbols used for the sidelink transmission of the first terminal device, processing time for decoding of sidelink control information (SCI) comprising the configuration information, processing time for preparing sidelink transmission to be transmitted in the CO, a pre-configured value, or Subcarrier Spacing (SCS) used in the CO.

In some embodiments, the second number is determined based on at least one of the following: the number of symbols used for the sidelink transmission of the first terminal device, processing time for decoding of sidelink control information (SCI) comprising the configuration information, processing time for preparing sidelink transmission to be transmitted in the CO, a pre-configured value, or Subcarrier Spacing (SCS) used in the CO.

In some embodiments, the flag comprise one of the following: an indicator of one bit, or a preamble signal transmitted by the first terminal device at a start of the CO.

In some embodiments, the type of the sidelink signal comprises at least one of the following: sidelink control signal, sidelink data signal, positive acknowledge or negative acknowledge of sidelink transmission, sidelink Channel-state information signal, sidelink system synchronization block, or sidelink discovery signal.

In some embodiments, the type of the sidelink transmission comprises at least one of the following: sidelink unicast transmission, sidelink groupcast transmission, or sidelink broadcast transmission.

In some embodiments, the type of the sidelink channel comprises at least one of the following: physical sidelink control channel, physical sidelink shared channel, physical sidelink feedback channel, physical sidelink broadcast channel, or physical sidelink discovery channel.

In some embodiments, the type of the CCA comprises at least one of the following: a type 2A of CCA, a type 2B of CCA, or a type 2C of CCA.

In some embodiments, the configuration information may indicate a sidelink terminal device which is allowed or unallowed to use the resource in the CO by indicating at least one of the following: an identification of the sidelink terminal device, or a type of the sidelink terminal device.

In some embodiments, the type of the sidelink terminal device which is allowed or unallowed to use the resource in the CO comprises at least one of the following: a terminal device which performs sidelink unicast transmission with the first terminal device, a terminal device which belongs to a group comprising the first terminal device, a terminal device which locates in a zone indicated by the first terminal device, a terminal device which locates within an indicated distance from the first terminal device, a terminal device from which the first terminal device receives a signal, a terminal device which is a target terminal device for receiving the sidelink transmission of the first terminal device, or a terminal device which receives the signal strength of the sidelink transmission of the first terminal device exceeds a strength threshold.

In some embodiments, the signal strength of the sidelink transmission comprises at least one of the following: Reference Signal Receiving Power (RSRP), or Reference Signal Receiving Quality (RSRQ).

In some embodiments, the configuration information indicates the scheduling information for at least one sidelink terminal device by indicating at least one of the following: a resource assigned to a sidelink terminal device for performing sidelink unicast transmission to the first terminal device, or a resource assigned to at least one sidelink terminal device for performing sidelink groupcast transmission in a group, wherein the group comprising the first terminal device.

In some embodiments, the second terminal device 120 may receive the configuration information by receiving at least one piece of sidelink control information (SCI) comprising the configuration information.

In some embodiments, the second terminal device 120 may receive first SCI which indicates at least the resource associated with the CO.

In some embodiments, the second terminal device 120 may receive second SCI which indicates at least one of the following: the start point in time domain for sidelink transmission in the CO, the flag indicating whether the CO is allowed to be shared, the priority threshold for the sidelink transmission in the CO, the priority of the sidelink transmission of the first terminal device, the type of the sidelink signal which is allowed to be transmitted in the CO, the type of the sidelink signal which is unallowed to be transmitted in the CO, the type of sidelink transmission which is allowed to be transmitted in the CO, the type of sidelink transmission which is unallowed to be transmitted in the CO, the type of the sidelink channel which is allowed to be transmitted in the CO, the type of the sidelink channel which is unallowed to be transmitted in the CO, the type of clear channel assessment (CCA) which is allowed to be performed in the CO, the sidelink terminal device which is allowed to use a resource in the CO, the sidelink terminal device which is unallowed to use a resource in the CO, or the type of the sidelink transmission of the first terminal device, or the scheduling information for at least one sidelink terminal device.

In some embodiments, the second terminal device 120 may receive the configuration information by receiving third SCI which at least comprises the scheduling information.

In some embodiments, the first SCI indicates at least one of the following: presence of the second SCI or a format of the second SCI.

In some embodiments, the first SCI indicates at least one of the following: presence of the third SCI, or a format of the third SCI.

In some embodiments, the second terminal device 120 transmits the sidelink transmission from a start point in time domain for sidelink transmission in the CO.

In some embodiments, the second terminal device 120 transmits a CPE signal before a start point in time domain for sidelink transmission in the CO.

In some embodiments, if the flag in the configuration information indicates that the CO is allowed to be shared, the second terminal device 120 transmits the sidelink transmission in the CO.

In some embodiments, if the second terminal device 120 determines that the second terminal device 120 is the sidelink terminal device which is allowed to use the resource in the CO, the second terminal device 120 transmits the sidelink transmission in the CO.

In some embodiments, if the second terminal device 120 determines that the configuration information indicates the resource not used by the first terminal device 110 or the idle resource in the CO, the second terminal device 120 transmits the sidelink transmission in the CO.

In some embodiments, if the second terminal device 120 determines that the resource not used by the first terminal device 110 or the idle resource in the CO is suitable for the sidelink transmission of the second terminal device 120, the second terminal device 120 transmits the sidelink transmission in the CO.

In some embodiments, if the second terminal device 120 determines that a CCA procedure succeeds, the second terminal device 120 transmits the sidelink transmission in the CO.

In some embodiments, if the second terminal device 120 determines that the priority of the sidelink transmission of the second terminal device 120 exceeds the priority threshold or the priority of the sidelink transmission of the first terminal device 110, the second terminal device 120 transmits the sidelink transmission in the CO.

In some embodiments, the second terminal device 120 performs a type 1 CCA procedure before receiving the configuration information. In such embodiments, if the second terminal device 120 determines that a resource in the CO is to be used for the sidelink transmission of the second terminal device 120, the second terminal device 120 stops the type 1 CCA procedure and transmits the sidelink transmission by using the resource in the CO.

Hereinafter, examples of the method 1100 will be described with reference to FIGS. 12 to 14.

FIG. 12 illustrates a flowchart of an example method 1200 in accordance with some embodiments of the present disclosure. In some embodiments, the method 1200 can be implemented at a terminal device, such as the second terminal device 120 as shown in FIG. 1. For the purpose of discussion, the method 1200 will be described with reference to FIG. 1 as performed by the second terminal device 120 without loss of generality.

At block 1210, the second terminal device 120 detects and decodes SCI of the first terminal device 110. The SCI comprises the configuration information about the CO determined by the first terminal device 110.

At block 1220, the second terminal device 120 determines whether the flag in the SCI indicates the CO is allowed to be shared.

If the flag in the SCI indicates the CO is not allowed to be shared, the method 1200 proceeds to block 1290. At block 1290, the second terminal device 120 does not transmit in current CO. On the other hand, if the flag in the SCI indicates the CO is allowed to be shared, at block 1230, the second terminal device 120 determines whether the second terminal device 120 is the sidelink terminal device which is allowed to use the resources in the CO.

If the second terminal device 120 is not the sidelink terminal device, the method 1200 proceeds to block 1290. On the other hand, if the second terminal device 120 is the sidelink terminal device, at block 1240, the second terminal device 120 determines whether there is an idle resource in the CO.

If there is not any idle resource in the CO, the method 1200 proceeds to block 1290. On the other hand, if there is an idle resource in the CO, at block 1250, the second terminal device 120 determines whether the idle resource is suitable for sidelink transmission of the second terminal device 120.

If the idle resource is not suitable for sidelink transmission of the second terminal device 120, the method 1200 proceeds to block 1290. On the other hand, if the idle resource is suitable for sidelink transmission of the second terminal device 120, at block 1260, the second terminal device 120 performs an LBT process to access a channel.

At block 1270, the second terminal device 120 determines whether a CCA procedure succeeds.

If the CCA procedure does not succeed, the method 1200 proceeds to block 1290. On the other hand, if the CCA procedure succeeds, at block 1280, the second terminal device 120 transmits sidelink transmission within the CO.

It should be noted that the order of actions at blocks 1230 and 1240 may be exchanged. In addition, some of actions as shown in FIG. 12 may be cancelled. For example, part or all of actions at blocks 1220, 1230, 1240, 1250 and 1270 may be cancelled. The scope of the present disclosure is not limited in this regard.

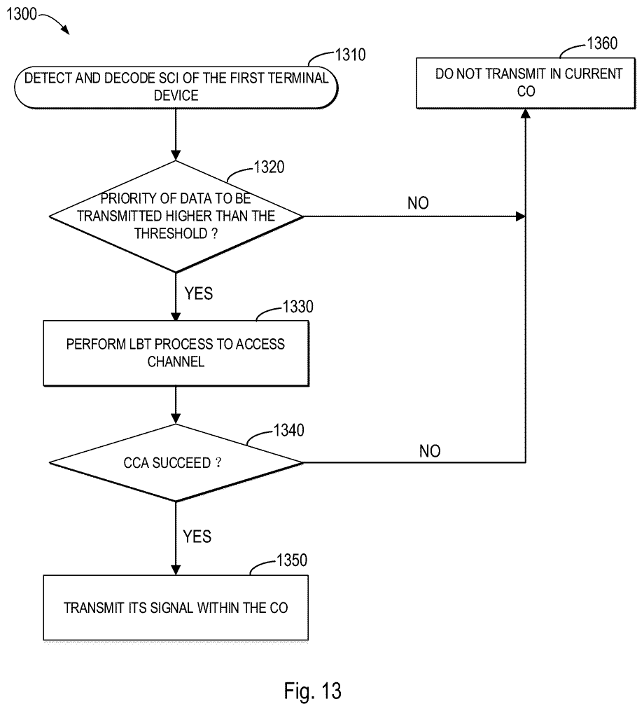

FIG. 13 illustrates a flowchart of an example method 1300 in accordance with some embodiments of the present disclosure. In some embodiments, the method 1300 can be implemented at a terminal device, such as the second terminal device 120 as shown in FIG. 1. For the purpose of discussion, the method 1300 will be described with reference to FIG. 1 as performed by the second terminal device 120 without loss of generality.

In the example method 1300, the second terminal device 120 acts as a target Rx terminal device of the transmission of the first terminal device 110.

At block 1310, the second terminal device 120 detects and decodes SCI of the first terminal device 110. The SCI comprises the configuration information about the CO determined by the first terminal device 110.

At block 1320, the second terminal device 120 determines whether the priority of data to be transmitted is higher than the priority threshold.

If the priority of data to be transmitted is not higher than the priority threshold, the method 1300 proceeds to block 1360. At block 1360, the second terminal device 120 does not transmit in current CO. On the other hand, if the priority of data to be transmitted is higher than the priority threshold, at block 1330, the second terminal device 120 performs an LBT process to access a channel. For example, if the second terminal device 120 needs to transmit sidelink ACK/NACK feedback on sidelink, the priority of the sidelink ACK/NACK information is higher than the priority threshold indicated by the first terminal device 110.

At block 1340, the second terminal device 120 determines whether a CCA procedure succeeds.

If the CCA procedure does not succeed, the method 1300 proceeds to block 1360. On the other hand, if the CCA procedure succeeds, at block 1350, the second terminal device 120 transmits sidelink transmission within the CO, that is, dropping the receiving of the signal from the first terminal device 110.

With the method 1300, the second terminal device 120 determines whether and how to share a resource in the CO. The method 1300 provides more flexibility of transmission of a terminal device and improves service reliability.

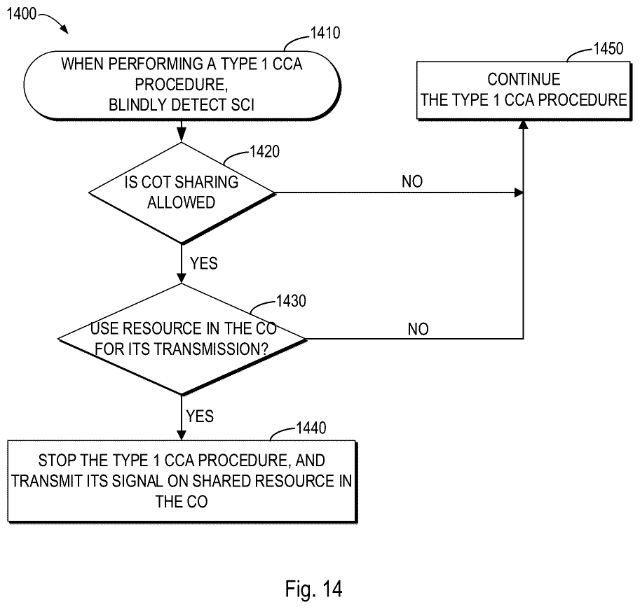

FIG. 14 illustrates a flowchart of an example method 1400 in accordance with some embodiments of the present disclosure. In some embodiments, the method 1400 can be implemented at a terminal device, such as the second terminal device 120 as shown in FIG. 1. For the purpose of discussion, the method 1400 will be described with reference to FIG. 1 as performed by the second terminal device 120 without loss of generality.

At block 1410, the second terminal device 120 detects SCI of the first terminal device 110 while the second terminal device 120 is performing a type 1 CCA procedure and tries to obtain a channel resource for its transmission.

At block 1420, the second terminal device 120 determines whether the flag in the SCI indicates the CO is allowed to be shared. If the flag in the SCI indicates the CO is not allowed to be shared, the method 1400 proceeds to block 1450. At block 1450, the second terminal device 120 continues the type 1 CCA procedure to obtain a resource. On the other hand, if the flag in the SCI indicates the CO is allowed to be shared, at block 1430, the second terminal device 120 determines whether to use a resource in the CO for its transmission.

If the second terminal device 120 determines to use a resource in the CO for its transmission, at block 1440, the second terminal device 120 stops the type 1 CCA procedure and transmits its signal on a shared resource in the CO.

In the example method 1400, the second terminal device 120 can share the resource in the CO of the first terminal device 110 instead of access a channel by using type 1 CCA procedure. It benefits transmission of the second terminal device 120 and decreases its transmission latency.

It should be noted that the action at block 1430 may be implemented as the examples described in FIGS. 12 and 13.

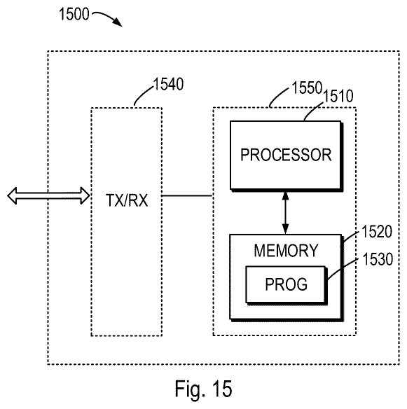

FIG. 15 is a simplified block diagram of a device 1500 that is suitable for implementing some embodiments of the present disclosure. The device 1500 can be considered as a further example embodiment of the terminal device 110 or the terminal device 120 as shown in FIG. 1. Accordingly, the device 1500 can be implemented at or as at least a part of the terminal device 110 or the terminal device 120.

As shown, the device 1500 includes a processor 1510, a memory 1520 coupled to the processor 1510, a suitable transmitter (TX) and receiver (RX) 1540 coupled to the processor 1510, and a communication interface coupled to the TX/RX 1540. The memory 1520 stores at least a part of a program 1530. The TX/RX 1540 is for bidirectional communications. The TX/RX 1540 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or cNB, Un interface for communication between the gNB or eNB and a relay node (RN), or Uu interface for communication between the gNB or eNB and a terminal device.

The program 1530 is assumed to include program instructions that, when executed by the associated processor 1510, enable the device 1500 to operate in accordance with the embodiments of the present disclosure, as discussed herein with reference to FIGS. 5 to 14. The embodiments herein may be implemented by computer software executable by the processor 1510 of the device 1500, or by hardware, or by a combination of software and hardware. The processor 1510 may be configured to implement various embodiments of the present disclosure. Furthermore, a combination of the processor 1510 and memory 1520 may form processing means 1550 adapted to implement various embodiments of the present disclosure.

The memory 1520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1520 is shown in the device 1500, there may be several physically distinct memory modules in the device 1500. The processor 1510 may be of any type suitable to the local technical network, and may include one or more of general purpose computers, special purpose computers, microprocessors, digital signal processors (DSPs) and processors based on multicore processor architecture, as non-limiting examples. The device 1500 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 2 to 12. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-61. (canceled)

62. A method performed by a first user equipment (UE) communicating with a second UE via a sidelink channel, the method comprising:
determining a channel occupancy (CO) for a sidelink transmission; and
transmitting, to the second UE, configuration information, wherein
the configuration information comprises:
a frequency resource used by the first UE,
a flag indicating whether the CO is allowed to be shared,
first identity,
a cast type of the sidelink transmission of the first UE,
information related to priority for the sidelink transmission,
a cast type of the sidelink transmission of the second UE,
second identity, and
a remaining duration of the CO.

63. The method according to claim 62, wherein
the cast type of the sidelink transmission of the first UE comprises sidelink unicast transmission, sidelink groupcast transmission, or sidelink broadcast transmission, and
the cast type of the sidelink transmission of the second UE comprises sidelink unicast transmission, sidelink groupcast transmission, or sidelink broadcast transmission.

64. The method according to claim 62, wherein
the sidelink channel comprises a Physical Sidelink Control Channel (PSCCH) or a Physical Sidelink Shared Channel (PSSCH).

65. A method performed by a second user equipment (UE) communicating with a first UE via a sidelink channel, the method comprising:
receiving, from the first UE based on a determination of a channel occupancy (CO) for a sidelink transmission, configuration information, wherein
the configuration information comprises:
a frequency resource used by the first UE,
a flag indicating whether the CO is allowed to be shared,
first identity,
a cast type of the sidelink transmission of the first UE,
information related to priority for the sidelink transmission,
a cast type of the sidelink transmission of the second UE,
second identity, and
a remaining duration of the CO, wherein
the method further comprises transmitting, based on the configuration information, the sidelink transmission.

66. The method according to claim 65, wherein
the cast type of the sidelink transmission of the first UE comprises sidelink unicast transmission, sidelink groupcast transmission, or sidelink broadcast transmission, and
the cast type of the sidelink transmission of the second UE comprises sidelink unicast transmission, sidelink groupcast transmission, or sidelink broadcast transmission.

67. The method according to claim 65, wherein
the transmitting, based on the configuration information, a sidelink transmission comprises:
transmitting the sidelink transmission that follows the sidelink transmission by the first UE after a transmission gap.

68. The method according to claim 66, wherein
the transmitting, based on the configuration information, a sidelink transmission comprises:
for the cast type of the sidelink transmission of the first UE indicating the sidelink unicast transmission, transmitting the sidelink unicast transmission based on the first identity,
for the cast type of the sidelink transmission of the first UE indicating the sidelink groupcast transmission, transmitting the sidelink groupcast transmission based on the first identity, or
for the cast type of the sidelink transmission of the first UE indicating the sidelink broadcast transmission, transmitting the sidelink broadcast transmission based on the first identity.

69. The method according to claim 66, wherein
the transmitting, based on the configuration information, a sidelink transmission comprises:
for the cast type of the sidelink transmission of the second UE indicating the sidelink unicast transmission, transmitting the sidelink unicast transmission based on the second identity,
for the cast type of the sidelink transmission of the second UE indicating the sidelink groupcast transmission, transmitting the sidelink groupcast transmission based on the second identity, or
for the cast type of the sidelink transmission of the second UE indicating the sidelink broadcast transmission, transmitting the sidelink broadcast transmission based on the second identity.

70. The method according to claim 65, wherein
the sidelink channel comprises a Physical Sidelink Control Channel (PSCCH) or a Physical Sidelink Shared Channel (PSSCH).

71. A first user equipment (UE) communicating with a second UE via a sidelink channel, the first UE comprising:
one or more memories storing instructions; and
one or more processors configured to process the instructions to control the first UE to:
determine a channel occupancy (CO) for a sidelink transmission; and
transmit, to the second UE, configuration information, wherein
the configuration information comprises:
a frequency resource used by the first UE,
a flag indicating whether the CO is allowed to be shared,
first identity,
a cast type of the sidelink transmission of the first UE,
information related to priority for the sidelink transmission,
a cast type of the sidelink transmission of the second UE,
second identity, and
a remaining duration of the CO.

72. The first UE according to claim 71, wherein
the cast type of the sidelink transmission of the first UE comprises sidelink unicast transmission, sidelink groupcast transmission, or sidelink broadcast transmission, and
the cast type of the sidelink transmission of the second UE comprises sidelink unicast transmission, sidelink groupcast transmission, or sidelink broadcast transmission.

73. The first UE according to claim 71, wherein
the sidelink channel comprises a Physical Sidelink Control Channel (PSCCH) or a Physical Sidelink Shared Channel (PSSCH).

74. A second user equipment (UE) communicating with a first UE via a sidelink channel, the first UE comprising:
one or more memories storing instructions; and
one or more processors configured to process the instructions to control the second UE to:
receive, from the first UE based on a determination of a channel occupancy (CO) for a sidelink transmission, configuration information, wherein
the configuration information comprises:
a frequency resource used by the first UE,
a flag indicating whether the CO is allowed to be shared,
first identity,
a cast type of the sidelink transmission of the first UE,
information related to priority for the sidelink transmission,
a cast type of the sidelink transmission of the second UE,
second identity, and
a remaining duration of the CO, wherein
the one or more processors are configured to process the instructions to control the second UE to transmit, based on the configuration information, the sidelink transmission.

75. The second UE according to claim 74, wherein
the cast type of the sidelink transmission of the first UE comprises sidelink unicast transmission, sidelink groupcast transmission, or sidelink broadcast transmission, and
the cast type of the sidelink transmission of the second UE comprises sidelink unicast transmission, sidelink groupcast transmission, or sidelink broadcast transmission.

76. The second UE according to claim 74, wherein
the one or more processors are configured to process the instructions to control the second UE to transmit the sidelink transmission that follows the sidelink transmission by the first UE after a transmission gap.

77. The second UE according to claim 75, wherein
the one or more processors are configured to process the instructions to control the second UE to:
for the cast type of the sidelink transmission of the first UE indicating the sidelink unicast transmission, transmit the sidelink unicast transmission based on the first identity,
for the cast type of the sidelink transmission of the first UE indicating the sidelink groupcast transmission, transmit the sidelink groupcast transmission based on the first identity, or
for the cast type of the sidelink transmission of the first UE indicating the sidelink broadcast transmission, transmit the sidelink broadcast transmission based on the first identity.

78. The second UE according to claim 75, wherein
the one or more processors are configured to process the instructions to control the second UE to:
for the cast type of the sidelink transmission of the second UE indicating the sidelink unicast transmission, transmit the sidelink unicast transmission based on the second identity,
for the cast type of the sidelink transmission of the second UE indicating the sidelink groupcast transmission, transmit the sidelink groupcast transmission based on the second identity, or
for the cast type of the sidelink transmission of the second UE indicating the sidelink broadcast transmission, transmit the sidelink broadcast transmission based on the second identity.

79. The second UE according to claim 74, wherein
the sidelink channel comprises a Physical Sidelink Control Channel (PSCCH) or a Physical Sidelink Shared Channel (PSSCH).
